(19) United States
(12) Patent Application Publication
(10) Pub. No.: US 2022/0206440 A1
(43) Pub. Date: Jun. 30, 2022

(54) EMBEDDED WINDING MECHANISM FOR A WATCH

(71) Applicant: The Swatch Group Research and Development Ltd, Marin (CH)

(72) Inventors: Matthias IMBODEN, St-Blaise (CH); Alexandre HAEMMERLI, Neuchâtel (CH); Cédric NICOLAS, Neuchâtel (CH); Damien PRONGUE, Prêles (CH); Thierry HESSLER, St-Aubin (CH)

(73) Assignee: The Swatch Group Research and Development Ltd, Marin (CH)

(21) Appl. No.: 17/518,647

(22) Filed: Nov. 4, 2021

(30) Foreign Application Priority Data
Dec. 29, 2020 (EP) 20217684.8

(51) Int. Cl. G04C 1/06

(52) U.S. Cl. CPC G04C 1/067

(57) ABSTRACT

An embedded winding mechanism for a watch or an automatic watch. The watch or the automatic watch including a mainspring wheel configured to wind a mainspring, at least one electric motor and at least one oscillating weight. The embedded winding mechanism including at least one primary ratchet gear configured to mesh the mainspring wheel of the watch or an automatic watch when the at least one oscillating weight meshes the at least one primary ratchet gear, and at least one secondary ratchet gear configured to actuate the mainspring wheel of the watch or an automatic watch when the at least one electric motor actuates the at least one secondary ratchet gear.

### TECHNICAL FIELD

The present invention relates to a winding mechanism for a watch.

### STATE OF THE ART

For over one hundred years, automatic watches have enabled a mechanical watch to remain wound, and run perpetually, during normal use. The required energy is harvested from the mechanical motion resulting from the natural movements of the user. However, once stationary said mainspring wheel will slowly drain all the mechanically stored energy into the watch movement and after typically 48 to 80 h the watch will stop.

### SUMMARY OF THE INVENTION

The present invention relates to an embedded winding mechanism for a watch or an automatic watch; said watch or said automatic watch comprising a mainspring wheel configured to wind a mainspring, at least one electric motor and at least one oscillating weight; said embedded winding mechanism comprising at least one:
primary ratchet gear: said at least one primary ratchet gear is configured to mesh said mainspring wheel of said watch or an automatic watch when said at least one oscillating weight meshes said at least one primary ratchet gear; and,
secondary ratchet gear: said at least one secondary ratchet gear is configured to mesh said mainspring wheel of said watch or an automatic watch when said at least one electric motor meshes said at least one secondary ratchet gear.

Thanks to this arrangement, said at least one primary ratchet gear and said at least one secondary ratchet gear may wind said mainspring wheel of a classical mechanical watch when said watch or said automatic watch is worn and/or when said electric motor, preferably said stepper electric motor, driven by solar energy, winds said mainspring wheel.

Thanks to this arrangement, said oscillating weight is prevented from applying a torque to said electric motor. Furthermore, thanks to this arrangement, said electric motor is prevented from applying a torque to said oscillating weight.

According to an embodiment, said at least one primary ratchet gear comprises at least one first primary wheel and at least one second primary wheel and/or said at least one secondary ratchet gear comprises at least one first secondary wheel and at least one second secondary wheel.

According to an embodiment, said at least one primary ratchet gear, preferably said at least one second primary wheel is configured to be comprised by said at least one oscillating weight, said at least one primary ratchet gear, preferably said at least one first primary wheel is configured to be disposed on said mainspring wheel, said at least one secondary ratchet gear, preferably said at least one first secondary wheel is configured to be disposed on said at least one electric motor and/or said at least one secondary ratchet gear, preferably said at least one second secondary wheel is configured to be comprised by said at least one electric motor.

Thanks to one of those arrangements, said at least one primary ratchet gear may wind said mainspring wheel of a classical mechanical watch when said watch or said automatic watch is worn and/or when said electric motor, preferably said stepper electric motor, driven by solar energy, winds said mainspring wheel.

According to an embodiment, said at least one first primary wheel is configured to mesh said at least one second primary wheel.

According to an embodiment, said at least one second primary wheel is configured to actuate said at least one first primary wheel or said at least one first primary wheel is configured to actuate said at least one second primary wheel.

According to an embodiment, said at least one second secondary wheel is configured to actuate said at least one first secondary wheel or said at least one first secondary wheel is configured to actuate said at least one second secondary wheel.

According to an embodiment, said at least one second primary wheel is configured to be meshed by said at least one oscillating weight and said at least one first primary wheel is configured to mesh said mainspring wheel.

According to an embodiment, said at least one first primary wheel comprises at least one primary gear and said at least one second primary wheel comprises at least one primary pawl; said at least one primary pawl is configured to push said at least one first primary wheel via said at least one primary gear when said at least one oscillating weight meshes said at least one second primary wheel, or when said at least one oscillating weight rotates, and said at least one primary pawl is configured to slide up and over the primary teeth of said at least one primary gear when said mainspring wheel meshes said at least one first primary wheel or when said mainspring wheel rotates.

According to an embodiment, said at least one second secondary wheel is configured to be meshed by said at least one electric motor or said at least one second secondary wheel is configured to be actuated by said at least one electric motor, and said at least one first secondary wheel is configured to actuate said mainspring wheel or said at least one first secondary wheel is configured to mesh said mainspring wheel.

According to an embodiment, said at least one first secondary wheel comprises at least one secondary gear and said at least one second secondary wheel comprises at least one secondary pawl; said at least one secondary pawl is configured to push said at least one first secondary wheel via said at least one secondary gear when said at least one electric motor actuates said at least one second secondary wheel or said at least one electric motor meshes said at least one second secondary wheel, and said at least one secondary pawl is configured to slide up and over the secondary teeth of said at least one primary gear when said mainspring wheel actuates said at least one second secondary wheel or when said mainspring wheel meshes said at least one second secondary wheel.

Thanks to one of these arrangements, said at least one secondary ratchet gear may wind said mainspring wheel of a classical mechanical watch when said watch or said automatic watch is worn and/or when said electric motor, preferably said stepper electric motor, driven by solar energy, winds said mainspring wheel.

According to an embodiment, said at least one first primary wheel comprises at least one primary gear and said at least one second primary wheel comprises at least one primary pawl; said at least one primary pawl is configured to push said at least one first primary wheel via said at least one primary gear when said at least one oscillating weight meshes said at least one second primary wheel, and said at least one primary pawl is configured to slide up and over the primary teeth of said at least one primary gear when said mainspring wheel meshes said at least one first primary wheel.

According to an embodiment, wherein said at least one secondary ratchet gear comprises at least one first secondary wheel and at least one second secondary wheel; said at least one second secondary wheel is configured to be meshed by said at least one electric motor or said at least one second secondary wheel is configured to be actuated by said at least one electric motor, and said at least one first secondary wheel is configured to actuate said mainspring wheel or said at least one first secondary wheel is configured to mesh said mainspring wheel.

According to an embodiment, said at least one second secondary wheel is configured to actuate said at least one first secondary wheel.

According to an embodiment, said at least one first secondary wheel comprises at least one secondary gear and said at least one second secondary wheel comprises at least one secondary pawl; said at least one secondary pawl is configured to push said at least one first secondary wheel via said at least one secondary gear when said at least one electric motor actuates said at least one second secondary wheel or said at least one electric motor meshes said at least one second secondary wheel, and said at least one secondary pawl is configured to slide up and over the secondary teeth of said at least one primary gear when said mainspring wheel actuates said at least one second secondary wheel or when said mainspring wheel meshes said at least one second secondary wheel.

The present invention concerns a watch or an automatic watch comprising a mainspring wheel, at least one electric motor and at least one embedded winding mechanism according to an embodiment of the present invention.

According to an embodiment, said at least one oscillating weight comprises said at least one primary ratchet gear, preferably said at least one second primary wheel, said mainspring wheel comprises said at least one primary ratchet gear, preferably said at least one first primary wheel and/or said at least one electric motor comprises said at least one secondary ratchet gear, preferably said at least one first secondary wheel and/or said at least one second secondary wheel

Thanks to one of those arrangements, said at least one primary ratchet gear and said at least one secondary ratchet gear may wind said mainspring wheel of a classical mechanical watch when said watch or said automatic watch is worn and/or when said electric motor, preferably said stepper electric motor, driven by solar energy, winds said mainspring wheel.

### BRIEF DESCRIPTION OF THE DRAWINGS

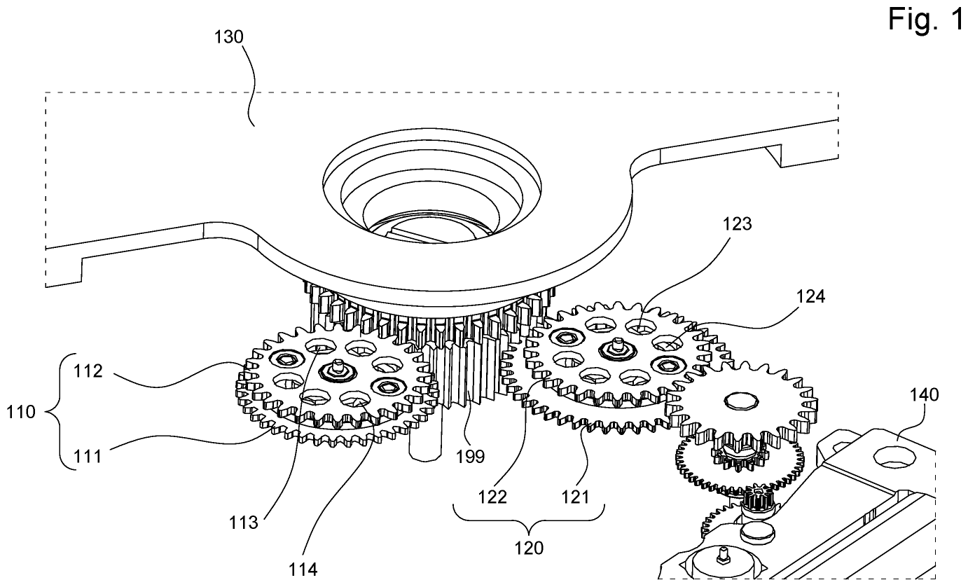

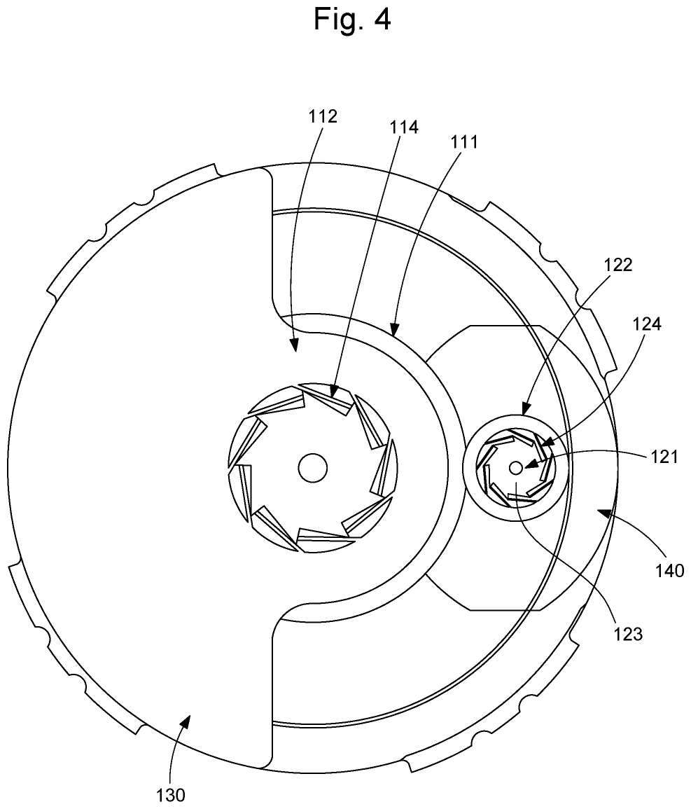

The foregoing and other purposes, features, aspects and advantages of the invention will become apparent from the following detailed description of the embodiments, given by way of illustration and not limitation with reference to the accompanying drawings, in which FIGS. 1-3C represent at least one primary ratchet gear 110 and at least one secondary ratchet gear 120 configured to wind said mainspring wheel 199. The FIG. 4 illustrates an embodiment according to the invention.

### DESCRIPTION OF THE INVENTION

Electric watch winders are already known. These winders are devices which may be used to prevent a self-winding watch from stopping when it is not worn for a certain period of time. Self-winding watches are fitted with a mechanism which automatically winds said mainspring wheel 199 using the arm movements of the person wearing the watch as the drive force. When a self-winding watch is worn, the movements cause an oscillating weight 130 provided for this purpose to rotate or oscillate inside the watch. The oscillating weight 130 is in turn arranged to transmit the energy which moves it to a gear train which winds said mainspring wheel 199. It will thus be clear that a self-winding watch which remains immobile is not wound.

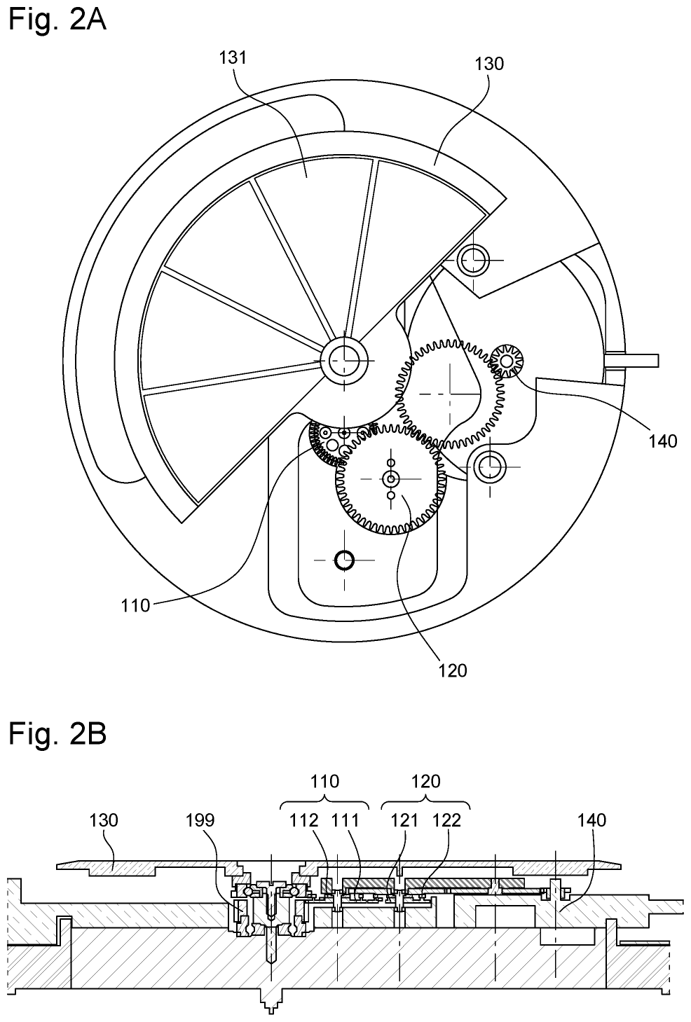

One place where a watch is especially likely to remain immobile for a long time is in a store window for instance. Indeed, it is not unusual for a large number of watches to be statically displayed in watch store window displays for example. The use of an embedded electric embedded winding mechanism 100 is thus particularly advantageous in this environment. Therefore, the present invention proposes a watch 200 or an automatic watch 200 comprising a mainspring wheel 199, at least one oscillating weight 130, at least one electric motor 140, which may be supplied via solar cell 131 comprised by said at least one oscillating weight 130 as depicted in FIG. 2A for instance, or said solar cell may be comprised in the bottom of a case of said watch 200, or may be formed by a dial and/or under a dial of said watch 200, and at least one embedded winding mechanism 100.

Said at least one embedded winding mechanism 100 may comprises at least one primary ratchet gear 110 and at least one secondary ratchet gear 120.

As depicted in FIG. 1, said at least one primary ratchet gear 110 is configured to mesh said mainspring wheel 199 of said watch 200 or an automatic watch 200 when said at least one oscillating weight 130 meshes said at least one primary ratchet gear 110. For that, said at least one primary ratchet gear 110 comprises at least one first primary wheel 111 and at least one second primary wheel 112. Said at least one second primary wheel 112 is configured to be meshed by said at least one oscillating weight 130 and said at least one first primary wheel 111 is configured to mesh said mainspring wheel 199 as depicted in FIGS. 2A and 2B. Preferably, said at least one second primary wheel 112 is configured to actuate said at least one first primary wheel 111 thanks at least one primary gear 113 and at least one primary pawl 114.

Indeed, said at least one first primary wheel 111 comprises at least one primary gear 113 and said at least one second primary wheel 112 comprises at least one primary pawl 114. Said at least one primary pawl 114 is configured to push said at least one first primary wheel 111 via said at least one primary gear 113 when said at least one oscillating weight 130 meshes said at least one second primary wheel 112, and said at least one primary pawl 114 is configured to slide up and over the primary teeth of said at least one primary gear 113 when said mainspring wheel 199 meshes said at least one first primary wheel 111 such as said at least one oscillating weight 130 is not meshed or is not actuated via said at least one second primary wheel 112.

On other side, said at least one secondary ratchet gear 120 is configured to mesh said mainspring wheel 199 of said watch 200 or an automatic watch 200 when said at least one electric motor 140 meshes said at least one secondary ratchet gear 120, preferably said at least one secondary ratchet gear 120 is configured to mesh said mainspring wheel 199 of said watch 200 or an automatic watch 200 via said at least one primary ratchet gear 110 when said at least one electric motor 140 meshes said at least one secondary ratchet gear 120 as depicted in FIGS. 2A-2B. For that, said at least one secondary ratchet gear 120 comprises at least one first secondary wheel 121 and at least one second secondary wheel 122. Said at least one second secondary wheel 122 is configured to be actuated or to be meshed by said at least one electric motor 140 and said at least one first secondary wheel 121 is configured to mesh said mainspring wheel 199 preferably via said at least one first primary wheel 111. Preferably, said at least one first secondary wheel 121 is configured to actuate said at least one second secondary wheel 122 thanks at least one secondary gear 123 and at least one secondary pawl 124.

Indeed, said at least one first secondary wheel 121 comprises at least one secondary gear 123 and said at least one second secondary wheel 122 comprises at least one secondary pawl 124. Said at least one second secondary wheel 122 is configured to push said at least one secondary gear 123 via said at least one secondary pawl 124 when said at least one electric motor 140 meshes or actuates said at least one second secondary wheel 122, and said at least one secondary pawl 124 is configured to slide up and over the secondary teeth of said at least one primary gear 123 when said mainspring wheel 199 meshes or actuates said at least one first secondary wheel 121 via said at least one first primary wheel 111 such as said at least one electric motor 140 is not meshed or is not actuated by said at least one second secondary wheel 122.

Thus, said at least one primary ratchet gear 110 and said at least one secondary ratchet gear 120 may wind said mainspring wheel 199 of a classical mechanical watch when said watch 200 or said automatic watch 200 is worn and/or when said electric motor 140, preferably said stepper electric motor 140, driven by solar energy, winds said mainspring wheel 199.

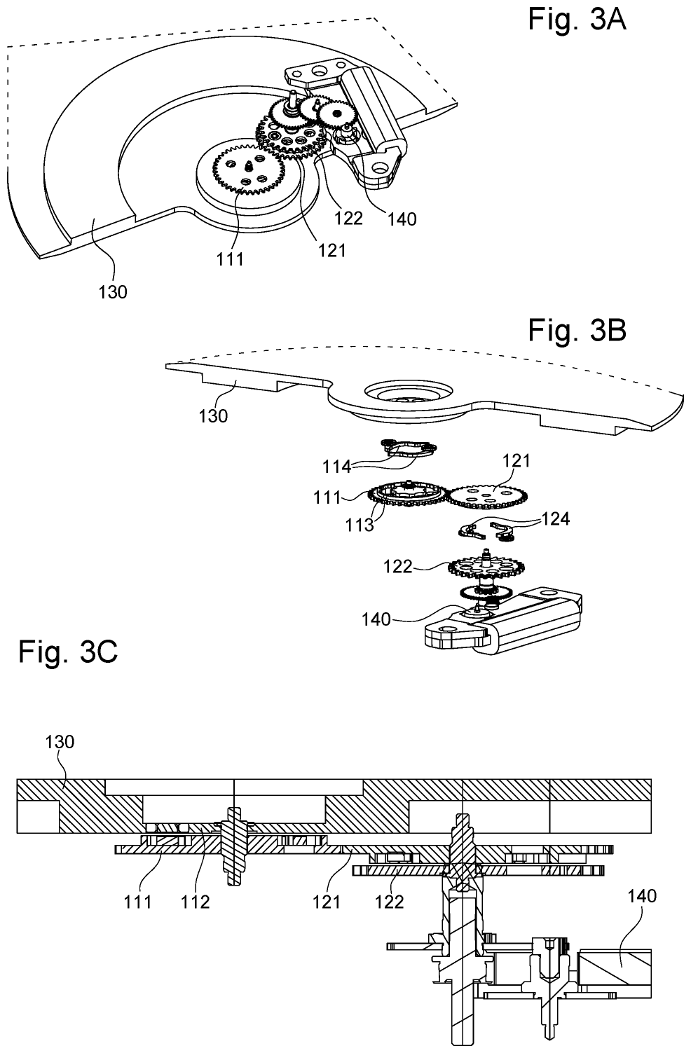

As depicted in FIGS. 3a-4, said at least one oscillating weight 130 may comprise said at least one primary ratchet gear 110, preferably said at least one second primary wheel 112 and said mainspring wheel 199, preferably said shaft of said mainspring wheel 199 may comprise said at least one first primary wheel 111. As it may be observed from FIG. 3, said at least one primary pawl 114 may be integrated in said at least one oscillating weight 130 and said at least one primary gear 113 may be disposed on said mainspring wheel 199, preferably said shaft of said mainspring wheel 199.

On other hand, said at least one electric motor 140 may comprise said at least one secondary ratchet gear 120, preferably the stator of said at least one electric motor 140 may comprise said at least one first secondary wheel 121, preferably said at least one secondary gear 123 and said at least one second secondary wheel 122, preferably said at least one secondary pawl 124 may be comprised between said at least one first primary wheel 111 and said at least one secondary gear 123. The major advantage of this embodiment is the number of pieces, which has been divided by at least two. Indeed, said at least one oscillating weight 130 may comprise said at least one primary pawl 114 and said shaft of said mainspring wheel 199 may comprise said at least one primary gear 113 such as to form said at least one primary ratchet gear 110, and said at least one electric motor 140 may comprise said at least one secondary gear 123 and said at least one secondary pawl 124 such as when said at least one oscillating weight 130 rotates around said shaft of said mainspring wheel 199, said at least one first secondary wheel 121 may not be moved by said at least one second secondary wheel 122 and said at least one electric motor 140 rotates, said at least one second secondary wheel 122 may not be moved by said at least one first primary wheel 111.

1. An embedded winding mechanism for a watch or an automatic watch; said watch or said automatic watch comprising a mainspring wheel configured to wind a mainspring, at least one electric motor and at least one oscillating weight; said embedded winding mechanism comprising at least one:
primary ratchet gear: said at least one primary ratchet gear is configured to mesh said mainspring wheel of said watch or an automatic watch when said at least one oscillating weight meshes said at least one primary ratchet gear; and,
secondary ratchet gear said at least one secondary ratchet gear is configured to mesh said mainspring wheel of said watch or an automatic watch when said at least one electric motor meshes said at least one secondary ratchet gear.

2. The embedded winding mechanism according to claim 1, wherein said at least one primary ratchet gear comprises at least one first primary wheel and at least one second primary wheel and/or said at least one secondary ratchet gear comprises at least one first secondary wheel and at least one second secondary wheel.

3. The embedded winding mechanism according to claim 1, wherein said at least one primary ratchet gear, said at least one second primary wheel is configured to be comprised by said at least one oscillating weight said at least one primary ratchet gear, said at least one first primary wheel is configured to be disposed on said mainspring wheel, said at least one secondary ratchet gear, said at least one first secondary wheel is configured to be disposed on said at least one electric motor and/or said at least one secondary ratchet gear, said at least one second secondary wheel is configured to be comprised by said at least one electric motor.

4. The embedded winding mechanism according to claim 1, wherein said at least one second primary wheel is configured to mesh said at least one first primary wheel.

5. The embedded winding mechanism according to claim 1, wherein said at least one second primary wheel is configured to actuate said at least one first primary wheel or said at least one first primary wheel is configured to actuate said at least one second primary wheel.

6. The embedded winding mechanism according to claim 1, wherein said at least one second secondary wheel is configured to actuate said at least one first secondary wheel or said at least one first secondary wheel is configured to actuate said at least one second secondary wheel.

7. The embedded winding mechanism according to claim 1, wherein said at least one second primary wheel is configured to be meshed by said at least one oscillating weight and said at least one first primary wheel is configured to mesh said mainspring wheel.

8. The embedded winding mechanism according to claim 1, wherein said at least one first primary wheel comprises at least one primary gear and said at least one second primary wheel comprises at least one primary pawl; said at least one primary pawl is configured to push said at least one first primary wheel via said at least one primary gear when said at least one oscillating weight meshes said at least one second primary wheel, or when said at least one oscillating weight rotates, and said at least one primary pawl is configured to slide up and over the primary teeth of said at least one primary gear when said mainspring wheel meshes said at least one first primary wheel or when said mainspring wheel rotates.

9. The embedded winding mechanism according to claim 1, wherein said at least one second secondary wheel is configured to be meshed by said at least one electric motor or said at least one second secondary wheel is configured to be actuated by said at least one electric motor and said at least one first secondary wheel is configured to actuate said mainspring wheel or said at least one first secondary wheel is configured to mesh said mainspring wheel.

10. The embedded winding mechanism according to claim 1, wherein said at least one first secondary wheel comprises at least one secondary gear and said at least one second secondary wheel comprises at least one secondary pawl said at least one secondary pawl is configured to push said at least one first secondary wheel via said at least one secondary gear when said at least one electric motor actuates said at least one second secondary wheel or said at least one electric motor meshes said at least one second secondary wheel, and said at least one secondary pawl is configured to slide up and over the secondary teeth of said at least one primary gear when said mainspring wheel actuates said at least one second secondary wheel or when said mainspring wheel meshes said at least one second secondary wheel.

11. A watch or an automatic watch comprising a mainspring wheel, at least one electric motor and at least one embedded winding mechanism according to according to claim 1.

12. The watch or an automatic watch according to claim 11, wherein said at least one oscillating weight comprises said at least one primary ratchet gear, said at least one second primary wheel, said mainspring wheel comprises said at least one primary ratchet gear, said at least one first primary wheel and/or said at least one electric motor comprises said at least one secondary ratchet gear, said at least one first secondary wheel and/or said at least one second secondary wheel.
